(19) United States
(12) Patent Application Publication
(10) Pub. No.: US 2005/0051577 A1
(43) Pub. Date: Mar. 10, 2005

(54) Fluid mixing device and dispensing system

(76) Inventors: Robert D. Loeb, Vista, CA (US); Thomas K. Bailey, San Diego, CA (US)

Correspondence Address: GORDON & REES LLP, 101 WEST BROADWAY, SUITE 1600, SAN DIEGO, CA, 92101, US

(21) Appl. No.: 10/655,286

(22) Filed: Sep. 4, 2003

(51) Int. Cl. B67D 5/60

(52) U.S. Cl. 222/145.6

(57) ABSTRACT

A fluid mixing device is formed as a one-piece unit having opposite inlet and outlet ends, a first, inlet bore portion extending from the inlet end for connection to a supply of a primary fluid under pressure, an outlet bore portion extending up to the outlet end, and a pair of spaced, relatively short, cylindrical venturi passageways of reduced cross-sectional dimensions extending from the inlet bore portion to the outlet bore portion, each venturi passageway having a throat. The unit has a first transverse inlet communicating with the first venturi passageway adjacent the throat for connection to a supply of a first secondary fluid and a second transverse inlet adjacent the throat of the second venturi passageway for connection to a supply of a second secondary fluid, whereby the secondary fluids are drawn into the primary fluid stream flowing in the respective venturi passageways.

### BACKGROUND OF THE INVENTION

The present invention relates generally to fluid mixing devices for mixing two or more fluids, such as liquids, gases, or mixtures of liquids and gases of differing viscosity. The invention also relates to fluid mixture dispensing systems using a fluid mixing device and a spray nozzle for dispensing a mixture of fluids, and is particularly concerned with a bathing, therapeutic bathing or cleaning system for dispensing a foaming or sudsing mixture of water, gases and cleaning liquid such as soap, detergent, therapeutic solutions, or shampoo for cleaning purposes.

Mixing of two or more different fluids is required for many different applications, such as in the chemical and petrochemical industries, fire fighting foams, aerated beverage production, and for producing a foaming mixture of detergent and water for cleaning, bathing, or the like. Cleaning and bathing systems for dispensing detergent and water mixtures have been subject to various disadvantages. One is that the water pressure must be high enough to produce sufficient agitation and foaming at the nozzle outlet, and this is often not the case. Some systems utilize air pumps for achieving sufficient pressure for adequate foaming at the output, but these are more complex and expensive.

Prior U.S. Pat. No. 6,293,294 of Loeb et al. describes a mixing device having an inlet passageway for connection to a primary fluid supply, such as water, an outlet passageway, and at least two separate venturi passageways between the inlet and outlet passageway, one connected to a first secondary fluid supply, and the other connected to a second secondary fluid supply. In one case, one of the secondary fluids is air and the other is a detergent or shampoo. The venturi passageways are separated by a flat septum, and the outlet passageway is spaced a substantial distance downstream of the venturi inlets. This arrangement provides efficient mixing and foaming at the outlet for an animal or other bathing or cleaning system. However, insufficient suction is produced at the mixing device if the water flow rate at the inlet is reduced to less than four gallons per minute. This unit is also susceptible to back pressure.

U.S. Pat. No. 2,719,704 of Anderson et al. describes a chemical mixing nozzle comprising an outer casing with a valve element rotatably mounted in the casing. Two separate, converging fluid conduits extend through the valve element, and are connected to the casing fluid supply inlet for water at one end, and the casing fluid outlet at the opposite end. One fluid conduit is connected to a container of fluid or chemical, and the other fluid conduit is connected to an air inlet. The valve element can be rotated into a first position where the fluid conduits are shut off from the air and fluid supplies, and water only is supplied to the outlet, a second position in which the fluid conduits are connected to the chemical and to air, respectively, to supply the chemical mixture to the outlet, and a third position in which water only is supplied to the outlet. This is a relatively complex mixing valve arrangement with several different parts.

In U.S. Pat. No. 2,800,313 of Targosh et al., a liquid mixing nozzle is described which has an outer tubular body, a separate venturi tube removably secured in the body between its ends, a water feed hose secured to one end of the tubular body via a hose coupling, and an outlet nozzle or the like connected to the opposite end of the tubular body. A radial inlet socket is provided in the body between its ends for connection to a bottle containing detergent or the like. The venturi tube has two parallel venturi passageways with tapered inlet portions, outwardly tapered outlet portions, a first transverse inlet in the tube connected to the first venturi passageway, and a second transverse inlet downstream of the first inlet connected to the second venturi passageway. The tubular body also has two air inlets for connection of the passageways to an air supply. The user must completely or partially cover the air inlets for control of suction and control of whether detergent is fed into the mixing valve. Again, this is a relatively complex, multi-part system.

Many prior art mixing devices and systems which do not use pumps may not have sufficient pressure for adequate cleaning at the outlet nozzle in some circumstances. In many known systems, air is added at the outlet nozzle or spray head, tending to soften the flow, rather than adding pressure.

### SUMMARY OF THE INVENTION

It is an object of the present invention to provide a new and improved mixing device and fluid mixture dispensing system.

According to one aspect of the present invention, a fluid mixing device is provided, which comprises a one-piece, integrally formed unit having opposite inlet and outlet ends, a first, inlet bore portion for connection to a supply of a primary fluid under pressure extending from the first end and having a second end spaced inwardly from the first end, an outlet bore portion having a first end spaced inwardly from the second, outlet end of the unit and extending from said first end to said outlet end, and a pair of spaced, cylindrical venturi passageways of reduced cross-sectional dimensions relative to the inlet and outlet bore portions each extending from the second end of the inlet bore portion to the first end of the outlet bore portion, each venturi passageway having a throat, and the tubular unit having a first transverse inlet adjacent the throat of the first venturi passageway for connection to a supply of a first fluid and a second transverse inlet adjacent the throat of the second venturi passageway for connection to a supply of a second fluid.

A transverse outlet may be provided in the unit, the outlet communicating with the inlet bore portion. The outlet comprises a flush or bypass outlet for flushing one of the venturi passageways in a rinse operation.

In an exemplary embodiment of the invention, the inlet bore portion has a first section of a first diameter extending from the inlet end of the unit, and a second section of a second diameter smaller than the first diameter extending from the first section up to the second end of the inlet bore portion. An annular shoulder is provided between the first and second sections, and the end of a hose connected to the primary fluid supply may be secured in the first section of the inlet bore portion in abutment with the annular shoulder, whereby there is substantially no change in diameter between the hose internal diameter and the diameter of the second section. An outlet hose may be secured in the outlet bore portion with its end abutting the inlet end of the outlet bore portion.

Each venturi passageway has a throat of a first diameter at the second end of the inlet bore portion, and may be of a constant, second diameter along the remainder of its length, with no taper. Alternatively, it may have a slight outward taper along all or part of its length from the throat to the first end of the outlet bore portion. The venturi passageways may be relatively short, and may be shorter in length than the inlet and outlet bore portions. The length of each venturi passageway is no less than half of the length of each of the inlet and outlet bore portions. The inlet bore portion is longer than the outlet bore portion.

The mixing device of this invention is easier to make and more compact than prior art fluid mixing devices. This also makes it less expensive to manufacture. It is made in one piece, and inlet and outlet hoses may be directly cemented in to the bore portions at opposite ends of the devices, avoiding the need for threading or pipe fittings or coupling nuts, although such devices may be used in alternative embodiments if desired. The mixing device may be machined by boring out opposite ends of a solid member of a suitably strong, rigid material such as metal or hard plastic to a predetermined distance, leaving a plug of solid material between the two bored portions, and then counterboring the plug to form two spaced venturi passageways, and finally forming transverse bores into the respective passageways at the appropriate position so that the fluids to which the transverse bores are connected will be drawn into the venturi passageways by suction, due to the venturi effect produced by the pressurized fluid flowing from the inlet bore portion into the venturi passageways. Instead of forming the member by machining, it may alternatively be formed by injection molding.

According to another aspect of the present invention, a fluid mixing and dispensing system is provided, which comprises an inlet hose connected to a supply of a primary fluid under pressure, an outlet hose connected to a spray nozzle, and a one-piece, unitary mixing device connected between the inlet and outlet hoses, the mixing device comprising a conduit member having an inlet end portion connected to the inlet hose, an outlet end portion connected to the outlet hose, and a pair of parallel venturi passageways of reduced cross-sectional dimensions extending between the inlet and outlet end portions, each venturi passageway having a throat, the tubular member having a pair of transverse venturi inlets communicating with the respective venturi passageways adjacent said throats, a first venturi inlet being connected to a supply of a first secondary fluid, and a second venturi inlet being connected to a supply of a second secondary fluid.

In one exemplary embodiment, the primary fluid was water, the first secondary fluid was air, and the second secondary fluid was detergent or shampoo. In this example, the system comprises a cleaning or bathing system, for example an animal or human bathing or shower system, a car wash system, or the like. In another embodiment, the first secondary fluid was oxygen, to provide an oxygen-rich, debriding solution for aiding in wound healing.

The tubular member may have a transverse outlet upstream of the venturi inlets for communicating with the inlet end portion. In one exemplary embodiment, a supply of a secondary fluid is connected via a conduit to the second venturi inlet, and a three-way valve is provided in the conduit, with a second conduit connected between the three-way valve and the transverse outlet. In a first position of the valve, supply of fluid to the transverse outlet is cut off, and the secondary fluid supply is connected to the second venturi inlet. In a second position of the valve, the secondary fluid supply is cut off from the second venturi inlet, and the second venturi inlet is instead connected to the transverse outlet. This means that the first fluid, most commonly water, is connected to the second venturi passageway to provide a flow of water flushing out the second venturi passageway in a rinse cycle of the system.

There may be more than one second secondary fluid supply, for example different shampoos or conditioners. These may be connected to the conduit via a multi-position valve for controlling which particular fluid is mixed into the first or primary fluid flowing through the mixing valve.

The fluid mixing device and system of this invention is simple and inexpensive to manufacture and use, requiring a reduced number of parts. It has a by-pass or rinse outlet built directly into the venturi or mixing device, which is a one-piece unit, and requires only a very small venturi section to produce adequate mixing with substantially no back flow. It will produce sufficient pressure at the spray head at lower inlet fluid flow rate and pressure than was possible with prior designs, and will also operate adequately under increased back pressure conditions, such as clogging of some of the outlets of the spray nozzle.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 is a side view of the mixing device according to an exemplary embodiment of the invention;

FIG. 2 is a sectional view taken on line 2-2 of FIG. 1;

FIG. 3 is an enlarged sectional view taken on line 3-3 of FIG. 2;

FIG. 4 is an enlarged sectional view taken on line 4-4 of FIG. 2;

FIG. 5 is a sectional view taken on line 5-5 of FIG. 2;

FIG. 6 is a schematic view of a washing or bathing system, incorporating the mixing device of FIGS. 1-4;

FIG. 7 is a view of a suitable control panel for the system;

FIG. 8 is a sectional view similar to FIG. 5, showing an alternative venturi configuration; and

FIG. 9 is a sectional view similar to FIG. 8, showing a further venturi configuration.

### DETAILED DESCRIPTION OF THE DRAWINGS

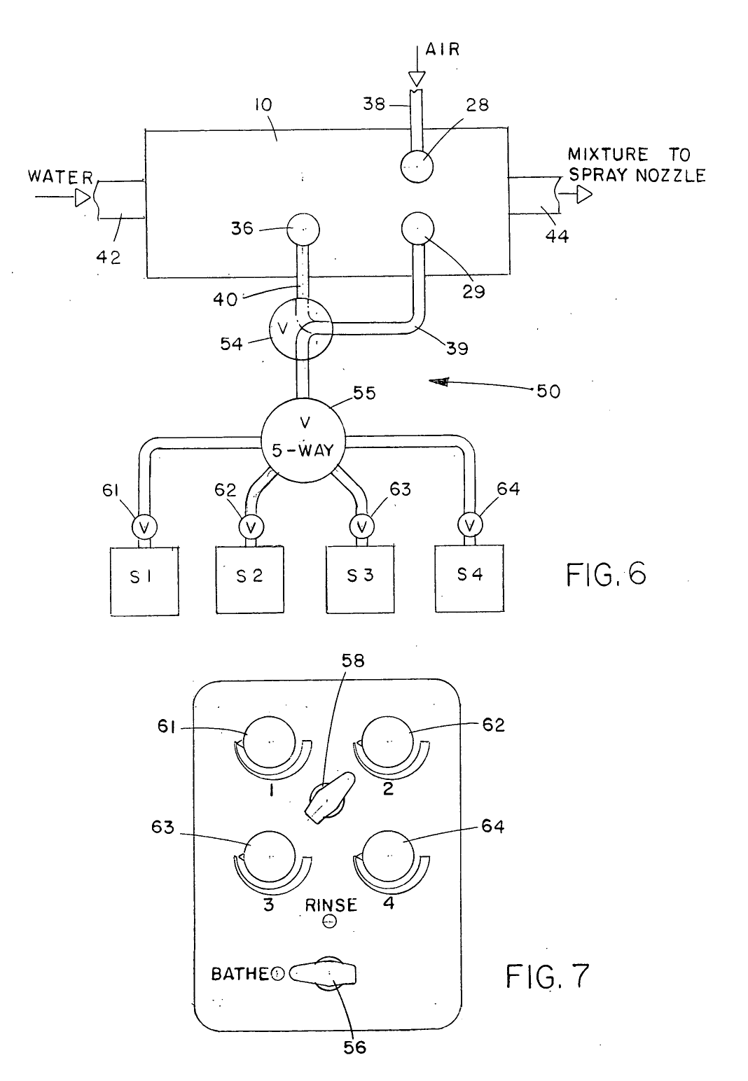

FIGS. 1 to 5 illustrate a one-piece, integrally formed or unitary venturi mixing device or conduit member 10 according to an exemplary embodiment of the present invention, while FIG. 6 illustrates the device incorporated in a bathing or washing system, such as an animal or human bathing system, a vehicle washing system, ear washing system, or the like.

The mixing device 10 comprises a solid block of a suitable, rigid material such as a hard plastic material, reinforced plastic material or metal, which is machined or otherwise formed to provide several bore portions. The block is of square or rectangular outer shape in the illustrated embodiment, but it may have a cylindrical or other outer peripheral shapes in other embodiments. The square or rectangular shape may make it easier to mount in an outer housing, however, and the member has a pair of mounting pads 12 for this purpose in the illustrated embodiment.

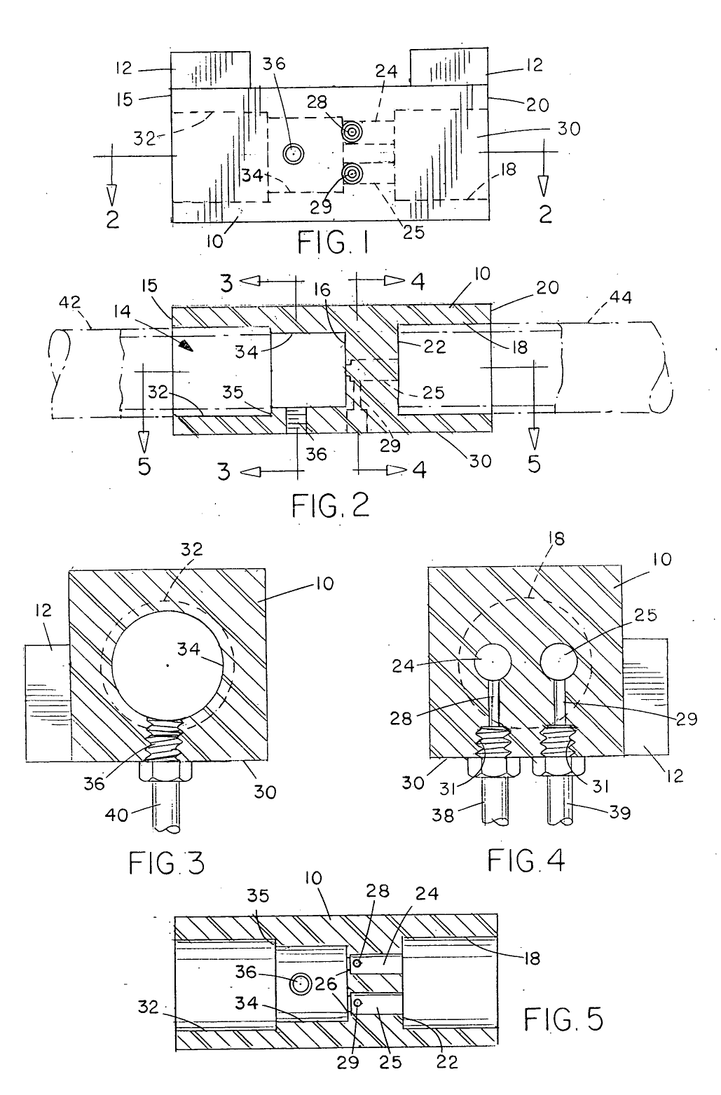

A first cylindrical bore portion 14 of stepped diameter is formed from a first, inlet end 15 of the member 10 up to an end wall 16, while a second cylindrical bore portion 18 of uniform diameter is formed from the second, outlet end 20 of member 10 up to an end wall 22 spaced from wall 16. Two spaced, parallel venturi passageways 24,25 are then formed through the remaining plug of material between end walls 16 and 20, each passageway having a reduced diameter throat 26 at its inlet end adjacent end wall 16, with the remainder of the passageway being of uniform diameter larger than the diameter of throat 26. Spaced, parallel first and second venturi inlets 28,29 are formed from one side face 30 of the member 10 into the respective venturi passageways, a short distance downstream of the respective throats 26, as best illustrated in FIGS. 2 and 4. In an exemplary embodiment of the invention, the distance between the central axis of each venturi inlet and the step or lip forming the throat 26 was approximately 0.059 inches.

The inlet bore portion 14 has a first section 32 extending from inlet end 15 and a second section 34 of smaller diameter extending from the first section up to end wall 16, with a step or annular shoulder 35 between the two sections. A by-pass outlet 36 is formed from the face 30 of member 10, at a location spaced upstream from the venturi inlets, into the second section 34 of inlet bore portion 14. By-pass outlet 36 is threaded for connection to a suitable pipe fitting for connecting the outlet to pipe 40 (FIG. 20). Each of the transverse venturi inlets may have a larger threaded portion 31 extending along part of its surface, as indicated in FIG. 4, for connection to a suitable pipe fitting to connect the inlets to conventional fluid supply hoses 38 and 39, respectively. The remainder of each venturi inlet is of narrower dimensions to provide proper venturi operation.

The fluid mixing device or member 10 can be readily manufactured in one piece by machining or by injection molding. Only simple and inexpensive tooling will be required to form the member 10 by machining. The mixing device is of relatively small and compact dimensions, requiring only a relatively small volume of material, further reducing costs. In one exemplary embodiment, the overall length of the device was around 2.9 to 3 inches, and the cross-sectional width was of the order of 1.25 inches.

In the illustrated embodiment, the inlet bore portion 14 is longer than the outlet bore portion 18 and the venturi passageways are shorter than either the inlet or outlet bore portion. All bore portions are of uniform diameter, not tapering, which makes machining easier, and the venturi passageways are also of uniform diameter apart from the stepped throats 26. The section of unit 10 containing the venturi passageways is relatively short in length, in the range from 0.3 to 0.5 inches, and in the exemplary embodiment is of the order of 0.38 to 0.40 inches.

The lengths of the first inlet bore portion 32 and the outlet bore portion 18 are approximately equal, suitably of the order of 0.9 inches, and their diameters are also approximately equal. The diameters of these bore portions are such that standard size inlet and outlet pipes 42,44 can be cemented into the respective inlet and outlet bore portions, with the end of pipe 42 abutting shoulder 35, and the end of outlet pipe 44 abutting the inner end wall 22. The diameter of the second inlet bore portion is substantially equal to the diameter of the bore in inlet pipe 42, as indicated in FIG. 2. This arrangement avoids the need for any screw threads in the inlet or outlet bore portions as well as any pipe fitting attachments for securing the pipes to mixing device or valve 10, making a more compact and inexpensive structure with fewer parts. The inlet and outlet pipes may be standard, half inch PVC water pipes or hoses, for example.

The mixing unit may be used for mixing together any combination of different fluids, but in an exemplary embodiment of the invention it is used to mix water supplied to the inlet bore portion with air supplied to the first venturi inlet 28 and a detergent or shampoo supplied to the second venturi inlet 29. Water supplied to inlet bore portion 14 flows through the unit 10 and along the two venturi passageways 24 and 25. The constricted throat portions of the venturi passageways will lower the pressure and increase the velocity of the water. This creates a negative pressure which draws fluid from each venturi inlet into the respective venturi passageway. In passageway 24, air is drawn in through inlet 28 and mixed with the water. In passageway 25, a detergent, shampoo, or other liquid is drawn in through inlet 29 and mixed with the water. The two streams, i.e. water and air in one passageway and water and detergent/shampoo in the other passageway, will meet and mix together in outlet bore portion 18, forming foam or suds which will be dispensed at the spray nozzle outlet of hose 44.

FIG. 6 illustrates a washing or bathing system 50 incorporating the fluid mixing unit 10 of FIGS. 1 to 5, while FIG. 7 illustrates a control panel 52 for controlling operation of the system 50. The control panel may be suitably provided on the front of a housing (not illustrated) in which the system is mounted. Inlet pipe or hose 42 is connected to a water supply (not illustrated), which may be the standard mains water supply, for example. Outlet hose 44 is connected to any suitable spray nozzle (not illustrated). The fluid supply hose 38 connected to the first venturi inlet is connected to an air inlet (not illustrated), which may simply be an open port on the outside of a suitable housing (not illustrated) in which the system 50 is mounted. Alternatively, hose 38 may be connected to a supply of oxygen or other gas.

Fluid supply hose 39 connected to the second venturi inlet 29 is connected via a three-way valve 54 to the outlet of a five-way valve 55. Fluid supply hose 40 connected to the by-pass outlet is also connected to the second inlet of the three-way valve 54. Three-way valve 54 is manually operated to connect supply hose 39, and thus venturi inlet 29, either to the five-way valve 55 as indicated in solid lines in FIG. 6, or to the hose 40 and flush inlet 36 as indicated in dotted lines.

Five-way valve 55 has four inlets connected to supplies S1,S2,S3 and S4 of different liquids, via concentration control needle valves 61-64. The liquids may be different shampoos, liquid soap, conditioners, detergents, or other bathing or cleaning agents. The position of five-way valve 55 determines which particular liquid is supplied to the mixing unit at any time. The position of valve 54 determines whether a selected liquid from one of the supplies is connected to the second venturi inlet, or whether the venturi inlet is instead connected to the flush outlet, supplying water from the inlet bore portion directly to the venturi passageway to flush any remaining detergent or shampoo from the passageway, and three-way valve, and to supply water only to the outlet nozzle in a rinse cycle.

FIG. 7 illustrates a control panel with control knobs 58, 56 for controlling the position of the valves 54, 55 respectively. Control knob 56 may be positioned as indicated in FIG. 7, pointing to “BATHE”, or may be rotated from that position to point to the word “RINSE”. In the illustrated position, valve 54 is in the solid line position of FIG. 6, connecting venturi inlet 29 to the four-way valve 55. In the second position, pointing to “RINSE”, the valve 54 is in the dotted line position of FIG. 6, connecting venturi inlet 29 to flush inlet 36. Control knob 55 may be positioned to point to any one of four needle valve dials 61,62,63,64 labeled 1 to 4, so as to connect venturi inlet 29 via valves 54 and 55 to one of the four liquid supplies S1 to S4 of FIG. 6. Additionally, the needle valve dials 61 to 64 can be rotated to control the amount of liquid flowing to venturi inlet 29.

Although the illustrated system allows selection between four different types of cleansing liquids, a greater or a lesser number of alternatives may be provided in alternative embodiments. This system is considerably more compact and requires fewer parts than prior art fluid mixing systems. Although the length of the venturi passageways is much less than in described in prior U.S. Pat. No. 6,293,294 referred to above, and the passageways do not have any tapered or flared portions, the fluid mixing and foaming effect has been found to be better than the prior art system. Also, it has been found, surprisingly, that the system of this invention is actually capable of working effectively when the incoming water pressure drops lower than was possible with the prior patented system of U.S. Pat. No. 6,293,294. In that system, the foaming or sudsing action worked well down to water flow rates as low as 5 gallons per minute, still creating sufficient suction (around 10 inches Hg) to draw air and detergent or shampoo into the water and create a sufficiently high pressure sudsing output. However, below this flow rate, there is much less suction and the system will not work well. With the system of the present invention, it has been found that it will still work well down to input flow rates of the order of 3-3.5 gallons per minute, creating suction of the order of 15-20 inches Hg at such flow rates, depending on the spray nozzle used and the output area of the nozzle (e.g. number of holes). This device will work well even with spray nozzles with as few as 16 holes. Thus, the new mixing valve unit will draw vacuum at lower flow rates and pressures and greater back pressure than the prior art arrangements, even though the venturi passageways are short, with no tapered sections. This is important when water pressure within the building is low, for example, when several devices are in use, simultaneously drawing water. The suction will be sufficient to draw even relatively high viscosity liquids into the mixing unit.

The provision of the flush or by-pass inlet directly into the mixing valve inlet bore portion is also an improvement over prior art arrangements with flush or rinse capability, shortening hose length, reducing the number of parts required, and reducing complexity of the system. Connection of the flush inlet directly to the second venturi passageway cuts off the supply of secondary fluid such as detergent or shampoo, and instead connects water to the venturi inlet, flushing water through the valve and supplying water only to the outlet for use in rinsing.

Mixing valve unit 10 has been found to have performance which is superior to that of the fluid mixing device described in U.S. Pat. No. 6,293,294 and other prior art mixing devices. Even though the venturi passageways are relatively short, and have no tapered portions, the step in diameter in each venturi passageway still produces sufficient vacuum to draw in fluid from the fluid supplies connected to the transverse venturi inlets, and there is little or no air backflow into the second venturi passageway 25. The unit 10 operates effectively at normal mains water supply pressure and flow rates, and will still draw a vacuum when the inlet flow and pressure drops significantly. It is also more resistant to back pressure on the line, due to long outlet hose or blocking or restriction of spray nozzle holes. In fact, a spray nozzle with fewer outlet holes can be used, while still producing a foamed output at sufficient pressure to produce an adequate cleaning or washing action.

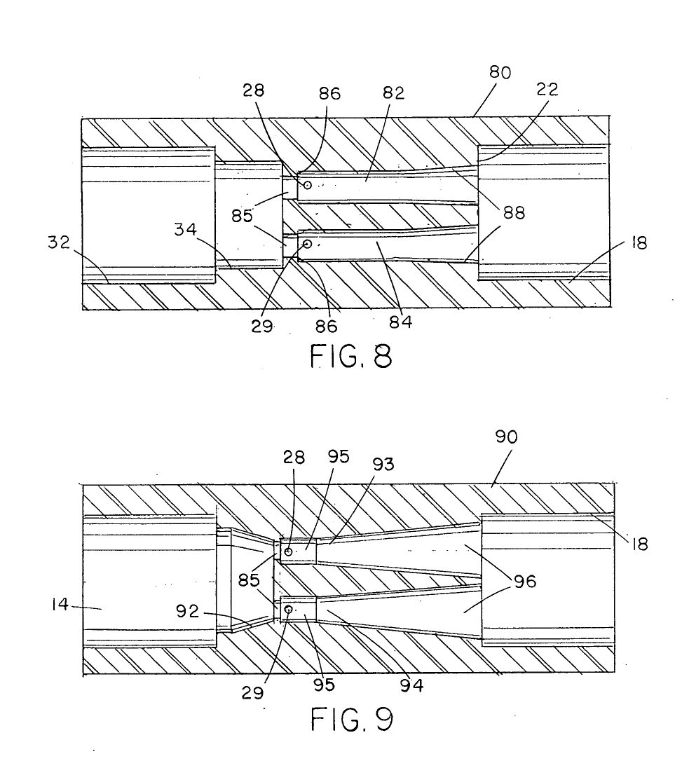

FIGS. 8 and 9 illustrate modified mixing valve units 80 and 90 with alternative venturi configurations. In FIG. 8, the inlet and outlet bore portions are identical to those of FIGS. 1 to 6, and like reference numerals have been used for like parts, as appropriate. There will also be a flush outlet 36 connected to inlet bore portion 34, although this is not visible in the sectional view of FIG. 8. As in the previous embodiment, there are two venturi passageways 82 and 84 between the inlet and outlet bore portions 14 and 18, but these are longer than the venturi passageways 24,25 of FIGS. 1 to 5. Each venturi passageway 82,84 has a throat portion 85 followed by a step 86 in diameter, and each has a slightly outwardly tapering end section 88. As in the first embodiment, venturi inlets 28,29 are connected to the respective venturi passageways 82,84 adjacent the throat portions 85.

FIG. 9 illustrates a slightly modified arrangement, in which the second bore section 92 of the inlet bore portion 14 is inwardly tapered along most of its length, and the venturi passageways 93,94 each have a straight portion 95 extending from throat portion 85, followed by an outwardly tapered portion 96 having a larger taper angle than the slight taper provided in the portions 88 of FIG. 8.

The mixing valve unit and fluid mixing and dispensing system of this invention can be used as a stand-alone bathing or washing unit for animals, vehicles, or the like, or may be built into a bathroom shower fixture, or a sink unit with a nozzle output for washing dishes. Most known animal bathing systems or other washing systems require higher water input pressures for adequate sudsing output. In the system described in U.S. Pat. No. 6,293,294, the air intake in one venturi would be reduced by a viscous fluid input in the other venturi. In the mixing valve unit of this invention, such effects are reduced, and the system is substantially unaffected by a viscous fluid supply to one of the venturis. This means that more air can be added to the mixture, both in the bathing and the rinsing cycle.

In the illustrated embodiments, the mixing unit is formed in one piece to provide inlet and outlet bore portions in which the ends of inlet and outlet hoses can be cemented, as well as a second inlet bore portion and venturi passageways extending from the second inlet bore portion to the outlet bore portion. It will be understood that the first inlet bore portion and/or the outlet bore portion may be eliminated in alternative embodiments which instead use coupling sleeves or pipe fittings to secure the ends of inlet and outlet hoses to the inlet and outlet ends of the fluid mixing unit. However, by providing integral end bore portions into which the hose ends can be directly cemented, as in the illustrated embodiment, construction is simplified and the number of required parts is reduced.

The fluid mixing unit is a simple, one piece member which can be easily and inexpensively machined from a block of a suitable rigid material such as rigid plastic, reinforced plastic, or metal, or may be injection molded from a suitable plastic material. The bore portions may each be of uniform diameter, requiring no tapers which are more difficult to machine or mold, and the overall unit is smaller than prior art arrangements, requiring only very short venturi passageways for effective operation. Although only two venturi passageways are provided in the illustrated embodiments, it will be understood that three or more such passageways and associated transverse inlets may be provided in other embodiments, simply by boring additional passageways between the inlet and outlet bore portions. This permits a primary fluid to be mixed with three or more secondary fluids, rather than just two secondary fluids, if desired.

Although some exemplary embodiments of the invention have been described above by way of example only, it will be understood by those skilled in the field that modifications may be made to the disclosed embodiments without departing from the scope of the invention, which is defined by the appended claims.

1. A fluid mixing device, comprising:
a one-piece, integrally formed unit having opposite inlet and outlet ends;
the unit having a first, inlet bore portion extending from the inlet end for connection to a supply of a primary fluid under pressure, the inlet bore portion having a second end spaced inwardly from the inlet end, and an outlet bore portion having a first end spaced inwardly from the second, outlet end of the unit and extending from said first end to said outlet end; and
a pair of spaced, cylindrical venturi passageways of reduced cross-sectional dimensions relative to the inlet and outlet bore portions each extending from the second end of the inlet bore portion to the first end of the outlet bore portion, each venturi passageway having a throat; and the unit having a first transverse inlet adjacent the throat of the first venturi passageway for connection of the first venturi passageway to a supply of a first secondary fluid and a second transverse inlet adjacent the throat of the second venturi passageway for connection of the second venturi passageway to a supply of a second secondary fluid.

2. The device as claimed in claim 1, wherein the unit has a transverse outlet communicating with the inlet bore portion, the transverse outlet comprising a flush outlet.

3. The device as claimed in claim 1, wherein the inlet bore portion has a first section of a first diameter extending from the inlet end of the unit, and a second section of a second diameter smaller than the first diameter extending from the end of the first section up to the second end of the inlet bore portion.

4. The device as claimed in claim 3, wherein the inlet bore portion has an annular shoulder between the first and second sections, the first section of the inlet bore portion having a diameter substantially matching that of a fluid supply hose for securing in the first section in abutment with the annular shoulder.

5. The device as claimed in claim 4, wherein the outlet bore portion has an internal diameter substantially equal to that of the first section of the inlet bore portion for receiving the end of an outlet hose.

6. The device as claimed in claim 1, wherein each venturi passageway has a throat of a first diameter at the second end of the inlet bore portion, and an enlarged portion of a larger diameter adjacent the throat, the first and second transverse inlets extending into the enlarged portions of the respective first and second venturi passageways.

7. The device as claimed in claim 6, wherein each venturi passageway has an inlet end at said throat and an outlet end, and is of a constant, second diameter from said throat to said passageway outlet end.

8. The device as claimed in claim 6, wherein each venturi passageway has an outward taper along at least part of its length from the throat to the first end of the outlet bore portion.

9. The device as claimed in claim 1, wherein the inlet bore portion, venturi passageways, and outlet bore portion are each of a predetermined length, the venturi passageways being of a shorter length than the inlet and outlet bore portions.

10. The device as claimed in claim 9, wherein the length of each venturi passageway is no less than half of the length of the inlet bore portion.

11. The device as claimed in claim 1, wherein the inlet bore portion is longer than the outlet bore portion.

12. The device as claimed in claim 1, further comprising an inlet hose having a first end for connection to a supply of said primary fluid and a second end directly secured in the first bore portion, an outlet hose having a first end directly secured in said second bore portion and a second end, and a spray nozzle secured to the second end of said outlet hose.

13. The device as claimed in claim 1, wherein the primary fluid is water, the first secondary fluid is a gas, and the second secondary fluid is a cleansing liquid for forming a foam when mixed with water and gas.

14. A fluid mixing and dispensing system, comprising:
an inlet pipe having a first end for connection to a supply of a primary fluid under pressure and a second end;
an outlet pipe having a first end and a second end for connection to a spray nozzle;
a mixing device connected between the second end of the inlet pipe and the first end of the outlet pipe, the mixing device comprising a one-piece, unitary member having an inlet bore portion connected to the second end of the inlet pipe, an outlet bore portion connected to the first end of the outlet pipe, and a pair of parallel venturi passageways of reduced cross-sectional dimensions extending between the inlet and outlet bore portions, each venturi passageway having a throat; and
the unitary member having first and second transverse venturi inlets communicating with the respective first and second venturi passageways adjacent said throats, the first venturi inlet being connected to a supply of a first secondary fluid, and the second venturi inlet being connected to a supply of a second secondary fluid.

15. The system as claimed in claim 14, wherein the primary fluid is water, the first secondary fluid is air, and the second secondary fluid is a cleaning liquid selected from the group consisting of soap, detergent, and shampoo.

16. The system as claimed in claim 14, wherein the unitary member has a transverse flush outlet upstream of the venturi inlets communicating with the inlet bore portion.

17. The system as claimed in claim 16, further comprising a three-way valve having a first inlet connected to the supply of second secondary fluid, a second inlet connected to said flush outlet, and an outlet connected to said second venturi inlet, the three-way valve being movable between a first position connecting said secondary fluid supply to said second venturi inlet and shutting off said flush outlet, and a second position shutting off said second secondary fluid supply from said second venturi inlet and connecting said flush outlet to said second venturi inlet.

18. The system as claimed in claim 17, including at least two different second secondary fluid supplies each having an outlet supply conduit, a multi-position valve having a plurality of inlets, each inlet connected to a respective one of said outlet supply conduits, and an outlet connected to the first inlet of said three-way valve.

19. The device as claimed in claim 14, wherein each venturi passageway has a throat of a first diameter at the second end of the inlet bore portion, and an enlarged portion of a larger diameter adjacent the throat, the first and second transverse inlets extending into the enlarged portions of the respective first and second venturi passageways.

20. The device as claimed in claim 19, wherein each venturi passageway has an inlet end at said throat and an outlet end, and is of a constant, second diameter from said throat to said passageway outlet end.

21. The device as claimed in claim 19, wherein each venturi passageway has an outward taper along at least part of its length from the throat to the first end of the outlet bore portion.

22. The device as claimed in claim 14, wherein the inlet bore portion, venturi passageways, and outlet bore portion are each of a predetermined length, the venturi passageways being of a shorter length than the inlet and outlet bore portions.

23 A fluid mixing device, comprising:
a conduit member having an inlet end and an outlet end;
the member having a first, inlet bore portion of a predetermined first length extending from the inlet end for connection to a supply of a primary fluid, the inlet bore portion having a second end spaced inwardly from the inlet end, and an outlet bore portion having a predetermined second length, the outlet bore portion having a first end spaced from said second end of said inlet bore portion and extending up to the outlet end of said conduit member; and
a pair of spaced venturi passageways of reduced cross-sectional dimensions relative to the inlet and outlet bore portions each extending from the second end of the inlet bore portion to the first end of the outlet bore portion, each venturi passageway having a throat;
the conduit member having a first transverse inlet adjacent the throat of the first venturi passageway for connection of the first venturi passageway to a supply of a first secondary fluid and a second transverse inlet adjacent the throat of the second venturi passageway for connection of the second venturi passageway to a supply of a second secondary fluid, whereby first and second secondary fluids are drawn into primary fluid streams flowing in the first and second venturi passageways, respectively; and
each venturi passageway having a third length corresponding to the distance between the second end of said inlet bore portion and the first end of said outlet bore portion and less than said first length.

24. The device as claimed in claim 23, wherein the conduit member is formed integrally in one piece.

25. The device as claimed in claim 23, wherein said third length is no less than half of said first length.

26. The device as claimed in claim 23, wherein said third length is in the range from 0.3 inches to 0.5 inches.

27. The device as claimed in claim 26, wherein said third length is approximately 0.4 inches.

28. The device as claimed in claim 23, wherein the inlet bore portion has a first section extending from said inlet end for receiving an end portion of a fluid supply hose, and a second section extending from said first section to said second end of said inlet bore portion.

29. The device as claimed in claim 28, wherein the second section is of smaller diameter than said first section.

30. The device as claimed in claim 28, wherein said member has a transverse by-pass inlet communicating with said second section of said inlet bore portion.

31. The device as claimed in claim 30, wherein said second section is of uniform diameter.

32. The device as claimed in claim 23, wherein each venturi passageway is a cylindrical bore, said throat being of reduced diameter relative to said cylindrical bore.

33. A fluid mixing device, comprising:
a conduit member having an inlet end and an outlet end;
the member having a first, inlet bore portion of a predetermined first length extending from the inlet end for connection to a supply of a primary fluid, the inlet bore portion having a second end spaced inwardly from the first end, and a pair of spaced, parallel cylindrical venturi passageways of reduced cross-sectional dimensions relative to the inlet bore portion each extending from the second end of the inlet bore portion and communicating with said outlet end, each venturi passageway having a throat;
the conduit member having a first transverse inlet adjacent the throat of the first venturi passageway for connection of the first venturi passageway to a supply of a first secondary fluid and a second transverse inlet adjacent the throat of the second venturi passageway for connection of the second venturi passageway to a supply of a second secondary fluid, whereby first and second secondary fluids are drawn into primary fluid streams flowing in the first and second venturi passageways, respectively; and
each venturi passageway having a second length less than the length of said inlet bore portion.

34. The device as claimed in claim 33, wherein said venturi passageways are non-tapered, cylindrical passageways.

35. The device as claimed in claim 34, wherein the inlet bore portion is non-tapered.

36. The device as claimed in claim 33, wherein the second length is no greater than 0.5 inches.

37. The device as claimed in claim 36, wherein the second length is approximately 0.4 inches.
